(19) United States
(12) Patent Application Publication
(10) Pub. No.: US 2008/0234035 A1
(43) Pub. Date: Sep. 25, 2008

(54) SYSTEM AND METHOD OF CONDUCTING GAMES OF CHANCE WITH ENHANCED PAYOUTS BASED ON CASH IN AMOUNT

(76) Inventor: Sean Malek, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 11/688,111

(22) Filed: Mar. 19, 2007

(51) Int. Cl. A63F 13/10

(52) U.S. Cl. 463/25

(57) ABSTRACT

A system and method of conducting games of chance with enhanced payouts based on a cash in or initial investment amount is disclosed. In response to a player's initial investment or cash in amount, a payout schedule is selected. The larger the initial investment the better the selected payout schedule for the player. Live games of chance, games of chance facilitated by electronic gaming machines or devices and server-based games may utilize the method disclosed herein.

### FIELD OF THE INVENTION

The embodiments of the present invention relate to a system and method of enhancing conventional game payouts based on a cash in amount or initial investment in a game of chance.

### BACKGROUND

Casinos are a mix of electronic gaming machines (e.g., slot machines) and live casino games (e.g., craps). Each game of chance has a corresponding pay table or payout schedule which provides the house or casino with an edge. Some games, such as video poker and slots, provide enhanced payouts when players play maximum coins. For example, a player playing five coins in video poker will be paid 4000 coins for a Royal Flush while the player will only receive 1600 coins if four coins are played. Similarly, with Megabucks slot machines, only players playing maximum coins are eligible for the multi-million dollar jackpot. While such enhancements have been popular, they are not useful with all games of chance and they force the player to play more coins per game than they want to play.

Therefore, it would be advantageous to provide a system and method of providing enhanced payouts for all games of chance. Moreover, the system and method should not require the player to wager any additional amounts on a per game basis.

### SUMMARY

Accordingly, a first embodiment of the present invention is a method comprising: accepting an initial investment from one or more players to participate in a game of chance; if the game of chance is facilitated by an electronic gaming machine, crediting the machine an amount equivalent to the initial investment; if the game of chance is a live game of chance, providing said one or more players with gaming chips equivalent to the initial investment; and selecting a payout schedule from a plurality of payout schedules wherein the payout schedules forming the plurality of payout schedules provide enhanced overall player payouts as an amount of the initial investment increases.

One gaming system embodiment of the present invention, including one or more electronic gaming machines having a processor, display and user interface, comprises: means for accepting an initial investment from a player to participate in a game of chance facilitated by an electronic gaming machine; crediting the machine an amount equivalent to the initial investment; and means for selecting a payout schedule from a plurality of payout schedules wherein the payout schedules forming the plurality of payout schedules provide enhanced overall player payouts as an amount of the initial investment increases.

The embodiments of the present invention provide players with enhanced payouts while possibly increasing a casino's bottom line. While players are not obligated to play the entirety of their initial investment (or cash in), some players tend to play longer with credits and gaming chips than they would if they were forced subsequently to cash in more money or travel to the ATM or cashier.

Other variations, embodiments and features of the present invention will become evident from the following detailed description, drawings and claims.

### BRIEF DESCRIPTION OF THE DRAWINGS

FIG. 1 illustrates a conventional video poker machine;

FIGS. 2a-2e illustrate four conventional video poker pay tables;

FIGS. 3a-3d illustrate an exemplary group of pay tables according to the embodiments of the present invention;

FIG. 4 illustrates a flow chart detailing a methodology associated with an embodiment of the present invention utilized with games of chance facilitated by electronic gaming machines;

FIG. 5 illustrates a conventional blackjack layout;

FIG. 6 illustrates an exemplary blackjack layout according to the embodiments of the present invention; and

FIG. 7 illustrates a flow chart detailing a methodology associated with an embodiment of the present invention utilized with live games of chance.

### DETAILED DESCRIPTION

For the purpose of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

The operation of slot machines, video poker machines, keno machines and other electronic gaming devices is controlled by microprocessors which communicate with internal memory devices and the external features of the machines. The microprocessors also incorporate, or communicate with, a random number generator which ensures the randomness of the machines' outcomes. In one of the embodiments of the present invention, one or more processors, along with memory and related devices, control the new applications disclosed herein. Therefore, the embodiments, along with the corresponding odds, of the present invention may be programmed into the processor or associated software. Since the technology for operating and controlling electronic gaming machines is well known to those skilled in the art, the subtle details are not described herein.

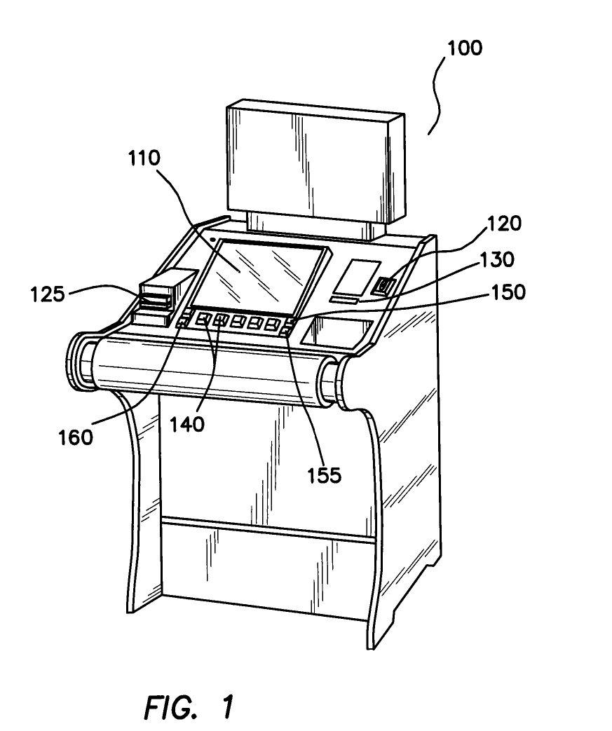

In one specific example, video poker machines and devices have been in existence for many years. Video poker machines utilize a processor that randomly organizes a deck of simulated cards. Once a wager is placed, the order of the cards is set. Cards are then provided to the player in order off the top of the simulated deck. Reference is now made to the figures wherein like parts are referred to by like numerals throughout. FIG. 1 illustrates an exemplary video poker machine generally referred to by reference numeral 100. The machine 100 includes a display 110, coin input 120, card reader 125, bill or coupon acceptor 130 and interface buttons, including hold/discard buttons 140, deal/draw button 150, play max coins button 155 and cash out button 160. In lieu of, or in addition to, all operations achieved using the interface buttons may be accomplished via touch screen implementation.

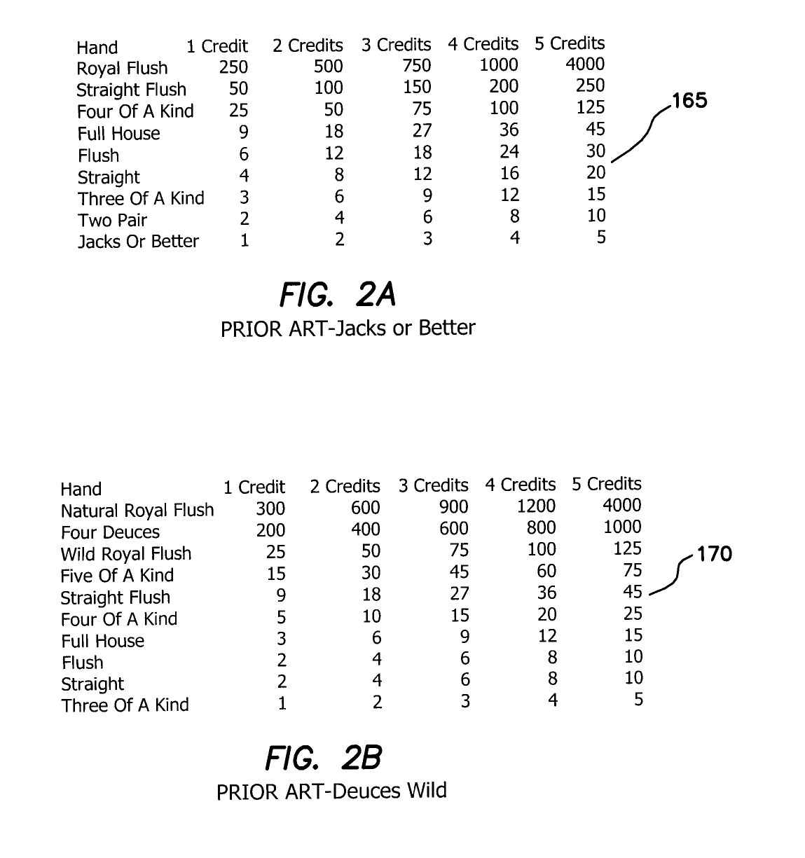

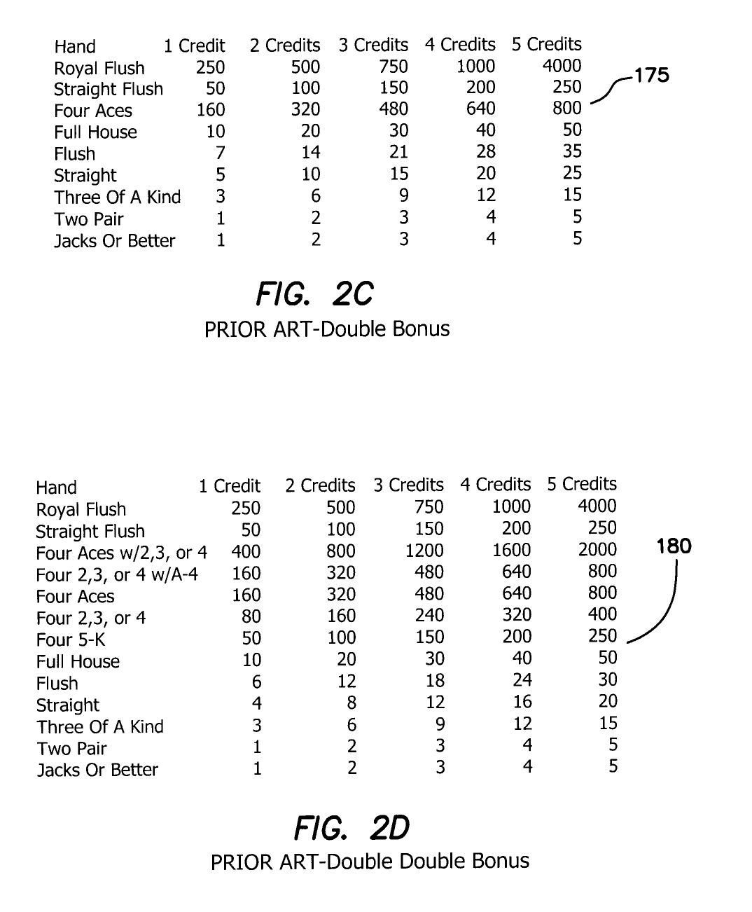

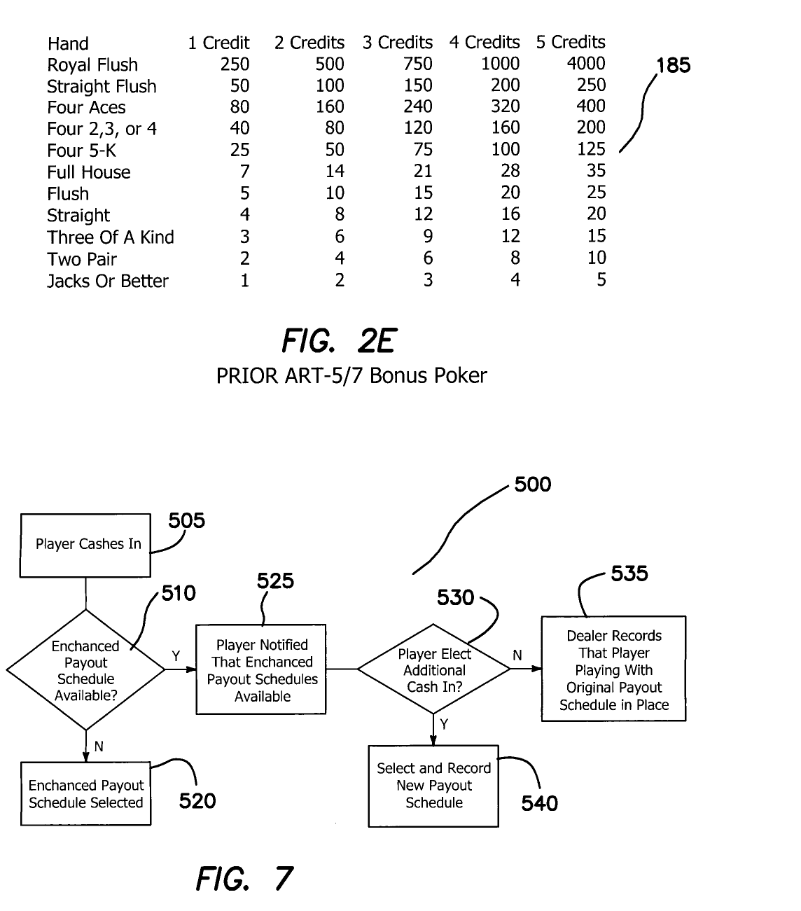

FIGS. 2a-2e show conventional pay tables for various video poker games currently played in casinos. The pay tables 165-185 correspond to Jacks or Better, Deuces Wild, Double Bonus Poker, Double Double Bonus Poker and 5/7 Bonus Poker video poker games. The payout schemes are substantially similar with subtle nuances. Each pay table comprises payouts relative to 1 to 5 coins being played. In almost every instance the payouts have a direct relationship to the number of coins played. So, if two coins are played the payout is twice that of the same payout for one coin being played and if four coins are played the payout is four times that of same payout for one coin being played. However, each pay table provides an enhanced payout for a player having five coins (i.e., maximum coins) being played and obtaining a Royal Flush. In such instances, the payout is not five times that of the same payout for one coin being played but is 10 times. Therefore, many players play five coins because they want the enhanced payout if they hit the Royal Flush. Of course, the odds of hitting a Royal Flush are small at approximately 1 in 40,000.

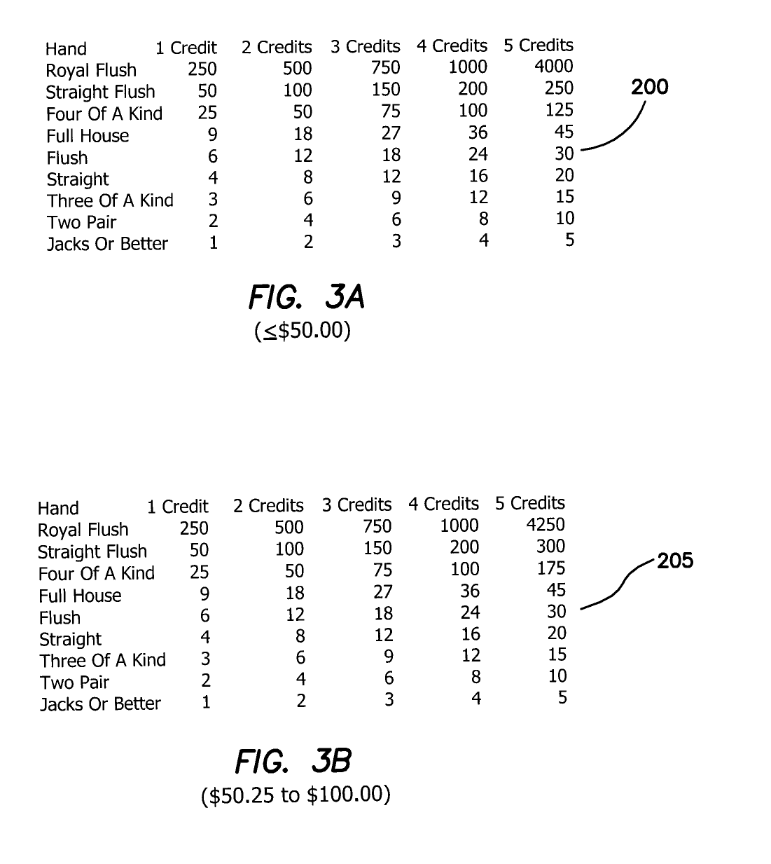

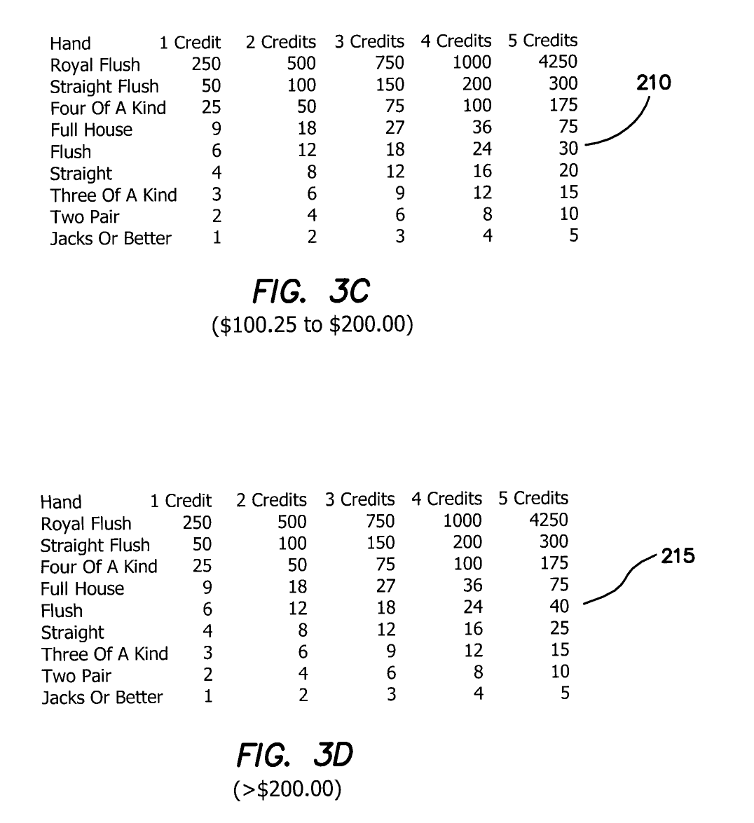

The embodiments of the present invention provide players with enhanced payouts based on the amount of their cash-in or initial investment in a game of chance. That is, the amount of money (or coupons, tickets or the like) a player places into the video poker machine to initiate play influences payouts. Using video poker as an example, FIGS. 3a-3d show four unique Jacks of Better pay tables 200-215 corresponding to four different ranges of cash-in amounts associated with a quarter machine. Similar enhanced payout schedules may be generated for other video poker variations (e.g., Deuces Wild) as well. Pay table 200 corresponds to a conventional Jacks or Better pay table used in response to a player cashing in for $50 or less. Pay table 205 is used for cash-in amounts ranging between $50.25 and $100.00 and provides enhanced payouts for Royal Flush, Straight Flush and Four of a Kind outcomes with 5 coins played. Pay table 210 is used for cash-in amounts ranging between $100.25 and $200.00 and provides enhanced payouts for Royal Flush, Straight Flush, Four of a Kind and Full House outcomes with five coins played. Pay table 215 is used for cash-in amounts exceeding $200.00 and provides enhanced payouts for Royal Flush, Straight Flush, Four of a Kind, Full House, Flush and Straight outcomes with five coins played. Those skilled in the art will recognize that enhanced payouts may be generated for any winning outcomes, with any amount of coins played, and the enhancements may be manipulated in any manner desired. For example, the Royal Flush payout may be enhanced to 4100 coins rather than 4250 coins. Regardless of the pay table, the house or casino should have a suitable edge. Also, it is possible that some payouts related to specific outcomes may be reduced while others are increased. Ideally, the overall payouts related to higher cash-in amounts are greater for the player. In other words, a player has a greater chance of winning or receives a greater return with each enhanced pay table or schedule.

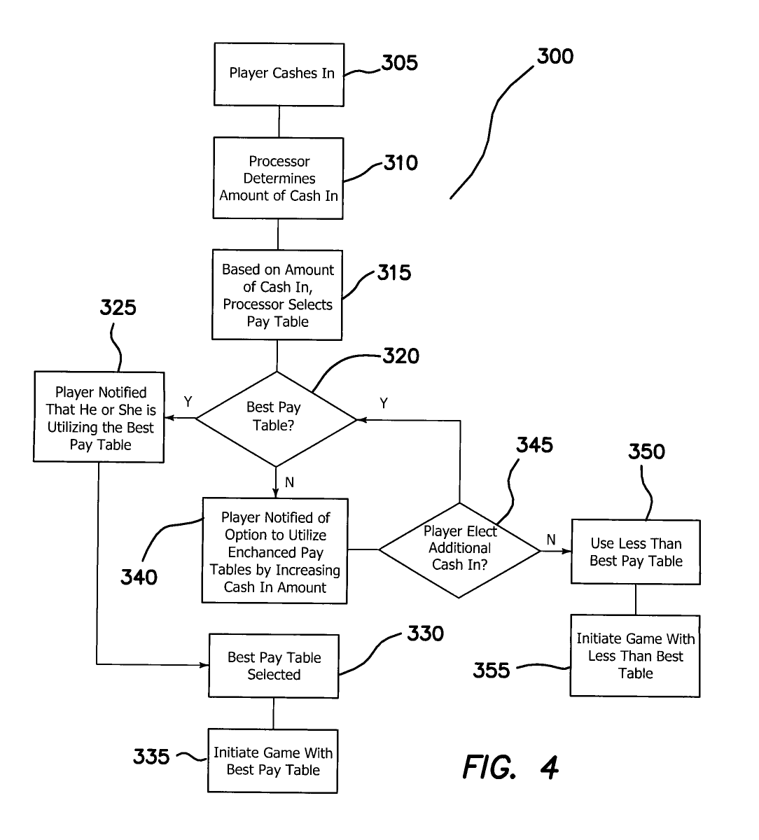

FIG. 4 shows a flow chart 300 detailing one embodiment of the present as utilized with an electronic gaming machine or device. Initially, at 305, a player cashes in by inserting currency, coupons or tickets into the machine. At 310, the processor determines the amount of the cash-in and based on the amount of the cash in, at 315, selects a corresponding pay table. At 320, the processor determines if the selected pay table is the best table available for the player. The best pay table means a pay table providing the best overall payout percentage for the player. In other words, the best pay table gives the player the best chance to win. Optionally, at 325, the processor causes the player to receive notification that the best pay table will be in play. At 330, the best table is selected and then, at 335, the game is initiated with the best pay table. If at 320, the best pay table is not to be selected, at 340, the player is prompted to insert additional money to change the current pay table to one with better player payouts. The prompt indicates how much money must be input to utilize one or more pay tables having enhanced payouts over the current pay table. If, at 345, the player declines to insert any additional money, at 350, the current pay table is selected and, at 355, the game is initiated using the selected pay table. If, at 345, the player inserts additional money, a new pay table, which may be the best table or not, is selected, and, at 360, the game is initiated with the selected pay table. The selected pay table remains in effect until the player cashes out the gaming session.

Depending on the casino, players may be permitted to change the pay table as often as possible by cashing out and cashing in regularly or the system may include restrictions such that players may have limited access to enhanced pay tables. For example, players may only be permitted to utilize the enhanced pay tables once per 24 hour period or other pre-determined time period or may only have access one certain days of the week or via invitation. Casino player tracking systems or the like may be responsible for maintaining information related to the number of times that a player has utilized the enhanced payout schedules.

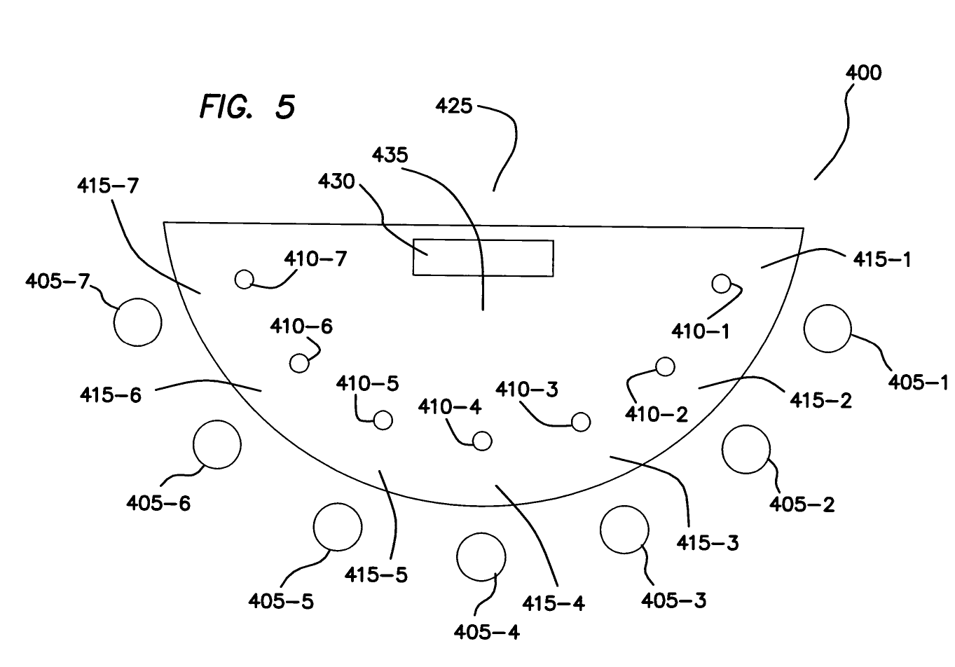

FIG. 5 shows a blackjack layout 400. The blackjack layout 400 accommodates seven player positions 405-1 through 405-7, seven player wager areas 410-1 through 410-7, seven player card areas 415-1 through 415-7, a dealer position 425, chip rack 430 and dealer card area 435. The blackjack table supporting the blackjack layout 400 may also support a card shoe and card shuffler. With conventional blackjack using six to eight decks winning wagers typically pay even money and 3 to 2 on a two card 21 (i.e., “Blackjack”). Because of the prevalence of card counting, when one or two decks of cards is used to play blackjack, many casinos now lower the Blackjack payout to even money as well.

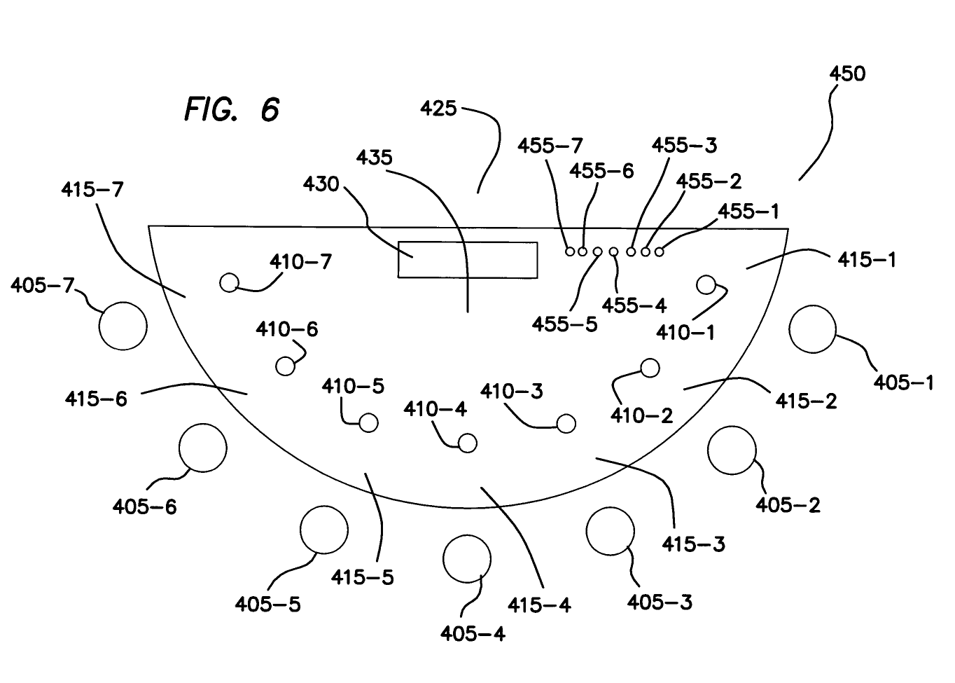

FIG. 6 shows a slightly modified blackjack layout 450 corresponding to the embodiments of the present invention. The modification to the layout 450 comprises player-corresponding circles 455 adjacent to the dealer position 425. The circles 455 provide a location for placement of payout indicators for each player position. Like the embodiment set forth above with respect to electronic gaming machines, the payouts are enhanced depending on the amount of money cashed in by each player. To track the payouts for each player, the dealer utilizes different payout chips indicative of a player's initial investment. So, with a two tiered payout structure a white chip may correspond to a conventional payout and a red chip may correspond to an enhanced payout. An electronic system may also be utilized to track which payouts correspond to which players. For example, most casinos have player tracking systems with monitors installed at most live games of chance which can be used as a reference by the dealer to maintain payout schedules for each player. With blackjack, for example, a larger initial investment, may result in a 3.5 to 1 payout on Blackjacks rather than 3 to 2 or even money. Other payouts, including payouts corresponding to even money wagers, double downs and split hands, may also be enhanced. While not shown, the unique pay tables may be printed on the layout so that players are able to immediately determine the pay table they want to play.

While blackjack is detailed above, other live table games, including Let It Ride and Caribbean Stud Poker, which have pay tables dedicated to low probability poker hands, may also utilize the embodiments of the present invention.

FIG. 7 shows a flow chart 500 detailing a live embodiment of the present invention. At 505, a player cashes in an amount of money. At 510, a dealer determines whether the amount cashed in entitles the player to an enhanced payout schedule. If the player has cashed-in enough to qualify for the best available payout schedule, at 520, the dealer selects and identifies, marks or otherwise maintains a record that the best payouts are being used for the player. If not, at 525, the dealer notifies the player that by cashing in more money the player will be entitled to a better payout schedule. If, at 530, the player declines to cash in additional money, at 535, the dealer selects and identifies, marks or otherwise maintains a record that the player is entitled to conventional payouts or other payouts less than the best payouts available. If, at 530, the player elects to cash in additional money, at 540, the dealer identifies, marks or otherwise maintains a record of the payout schedule to which the player is entitled.

Those skilled in the art will recognize that any game of chance, including, but not limited to craps, blackjack, keno, bingo and roulette, whether facilitated by electronic gaming machines or devices, or live games, may benefit from the embodiments of the present invention. Moreover, any slot machine can be configured to facilitate the embodiments of the present invention. The embodiments of the present invention are also suitable for online systems and server-based systems offering games of chance. With online and/or server-based systems, players access the games of chance from a remote server using a player terminal (dumb or smart), personal computer or hand-held device (e.g., cellular telephone or PDA) but the overall purpose of the embodiments of the present invention remains the same: to provide players with enhanced payout schedules for putting more money into the game.

The embodiments of the present invention benefit the player by providing enhanced payouts and provide the house or casino with a greater likelihood of winning at a higher rate because players have more money invested in the game. Even though players do not have to play all of the money initially invested or cashed in, players are more likely to play money already cashed in over money in their pockets or awaiting at the ATM or cashier.

Although the invention has been described in detail with reference to several embodiments, additional variations and modifications exist within the scope and spirit of the invention as described and defined in the following claims.

I claim:

1. A method of conducting a game of chance comprising:
accepting an initial investment from one or more players to participate in a game of chance;
if the game of chance is facilitated by an electronic gaming machine, crediting a player on the machine an amount equivalent to the initial investment;
if the game of chance is a live game of chance, providing players with gaming chips equivalent to the initial investment; and
selecting a payout schedule from a plurality of payout schedules wherein the payout schedules forming the plurality of payout schedules successively provide one or more increased payouts over a conventional payout schedule for the game of chance as an amount of the initial investment increases.

2. The method of claim 1 further comprising utilizing enhanced payout schedules having greater overall player return as an amount of the initial investment increases.

3. The method of claim 1 further comprising, in response to an initial investment not causing a best payout schedule to be selected, notifying the player that one or more enhanced payout schedules are available.

4. The method of claim 3 further comprising depicting on an electronic gaming machine display the notification that one or more payout schedules are available.

5. The method of claim 3 wherein casino personnel are responsible for notifying players that one or more enhanced payout schedules are available.

6. The method of claim 3 further comprising allowing the player to add to the initial investment in response to the notification that one or more payout schedules are available.

7. The method of claim 1 further comprising limiting, during a pre-determined time period, a number of times that the enhanced payout schedules may be used by each player.

8. The method of claim 1 wherein the electronic gaming machine comprises a slot machine, video poker machine, keno machine, blackjack machine, bingo machine, online system including a player terminal or a server-based system including a player terminal.

9. A method of conducting a live game of chance comprising:
accepting an initial investment from one or more players to participate in the live game of chance;
providing players with gaming chips equivalent to the initial investment;
selecting a payout schedule from a plurality of payout schedules wherein each payout schedule forming the plurality of payout schedules successively provides one or more enhanced payouts over a conventional payout schedule for the game of chance as an amount of the initial investment increases; and
recording a payout schedule corresponding to each one or more player.

10. The method of claim 9 further comprising utilizing enhanced payout schedules having greater overall player return as an amount of the initial investment increases.

11. The method of claim 9 further comprising, in response to an initial investment not causing a best payout schedule to be selected, a dealer notifying the player that one or more enhanced payout schedules are available.

12. The method of claim 9 further comprising recording the payout schedule by placement of a player chip on a corresponding marking on a gaming table layout.

13. The method of claim 9 further comprising limiting, during a pre-determined time period, a number of times that the enhanced payout schedules may be used by each player.

14. The method of claim 9 wherein the game of chance comprises blackjack, craps, roulette or baccarat.

15. A method of conducting a game of chance facilitated by an electronic gaming machine comprising:
accepting an initial investment from players to participate in the game of chance facilitated by the electronic gaming machine;
crediting the machine an amount equivalent to the initial investment; and
selecting a payout schedule from a plurality of payout schedules wherein each payout schedule forming the plurality of payout schedules successively provides one or more enhanced payouts over a conventional payout schedule for the game of chance as an amount of the initial investment increases.

16. The method of claim 15 further comprising utilizing enhanced payout schedules having greater overall player return as an amount of the initial investment increases.

17. The method of claim 15 further comprising, in response to an initial investment not causing a best payout schedule to be selected, notifying the player on a gaming machine display that one or more enhanced payout schedules are available.

18. The method of claim 15 further comprising limiting, during a pre-determined time period, a number of times that the enhanced payout schedules may be used by each player.

19. The method of claim 15 wherein the game of chance comprises slots, video poker, keno, bingo or blackjack.

20. The method of claim 15 wherein the electronic gaming machine comprises a slot machine, video poker machine, keno machine, blackjack machine, bingo machine, online system including a player terminal or a server-based system including a player terminal.

21. A gaming system including one or more electronic gaming machines each having a processor, display and user interface comprising:
means for accepting an initial investment from a player to participate in a game of chance facilitated by an electronic gaming machine;
crediting the machine an amount equivalent to the initial investment; and
means for selecting a payout schedule from a plurality of payout schedules wherein the payout schedules forming the plurality of payout schedules successively provide one or more enhanced payouts over a conventional payout schedule for the game of chance as an amount of the initial investment increases.

22. The method of claim 21 further comprising utilizing enhanced payout schedules having greater overall player return as an amount of the initial investment increases.

23. The gaming system of claim 21 further comprising means for notifying the player that one or more enhanced payout schedules are available.

24. The gaming system of claim 21 wherein the means for notifying the player that one or more enhanced payout schedules are available comprises at least the processor and display.

25. The gaming system of claim 21 further comprising means for limiting, during a pre-determined time period, a number of times that the enhanced payout schedules may be used by players.

26. The gaming system of claim 21 wherein the means for accepting the initial investment from the player comprises at least the processor and a bill or coupon reader.

27. The gaming system of claim 21 wherein the means for selecting a payout schedule comprises at least the processor.

28. An electronic gaming machine comprising:
a processor;
a display;
a user interface;
a bill or coupon reader for accepting an initial investment from a player to play the electronic gaming machine wherein the initial investment is credited to the electronic gaming machine; and
wherein the processor selects a payout schedule from a plurality of payout schedules wherein the plurality of payout schedules provide enhanced player payouts as an amount of the initial investment increases.

29. The gaming machine of claim 28 wherein the processor, in response to a best payout schedule not being selected, notifies the player that one or more enhanced payout schedules are available.

30. A gaming network including a user interface linked to a system offering games of chance comprising:
means for accepting an initial investment from a player to participate in a selected game of chance;
crediting the system an amount equivalent to the initial investment; and
means for selecting a payout schedule from a plurality of payout schedules wherein the plurality of payout schedules provide enhanced player payouts as an amount of the initial investment increases.

31. The gaming network of claim 30 wherein the system is an online system and/or a server-based system.

32. The gaming network of claim 30 wherein the user interface is a player terminal, electronic hand-held device or personal computer.
